(19) United States
(12) Patent Application Publication
(10) Pub. No.: US 2013/0049706 A1
(43) Pub. Date: Feb. 28, 2013

(54) CIRCUIT FOR DISCHARGING AN X CAPACITOR

(71) Applicants: Kuo-Chien Huang, Hsin-Chu (TW); Shun-Chin Chou, Hsin-Chu (TW); Ming-Chang Tsou, Hsin-Chu (TW)

(72) Inventors: Kuo-Chien Huang, Hsin-Chu (TW); Shun-Chin Chou, Hsin-Chu (TW); Ming-Chang Tsou, Hsin-Chu (TW)

(21) Appl. No.: 13/598,552

(22) Filed: Aug. 29, 2012

(30) Foreign Application Priority Data
Aug. 31, 2011 (TW) 100131375

(51) Int. Cl. H02J 7/00

(52) U.S. Cl. 320/166

(57) ABSTRACT

A circuit for discharging an X capacitor includes an AC detection unit, a reset unit, a counter, and a discharging unit. The AC detection unit is coupled to two terminals of the X capacitor through a pin. The AC detection unit has a plurality of reference levels for detecting a DC voltage level according to the plurality of reference levels, and outputting a detection signal. The reset unit is coupled to the AC detection unit for generating a reset signal according to the detection signal. The counter is coupled to the reset unit for being reset according to the reset signal. When the counter does not receive the reset signal within a first predetermined time, the counter generates a turning-on signal. The discharging unit is coupled to the counter for discharging the X capacitor according to the turning-on signal.

### BACKGROUND OF THE INVENTION

1. Field of the Invention

The present invention is related to a circuit for discharging an X capacitor, and particularly to a circuit that can determine whether an alternating current (AC) power is turned off or not according to a plurality of reference levels and discharge an X capacitor according to a determination result.

2. Description of the Prior Art

In order to prevent a user from suffering an electric shock when the user touches an electronic device, a circuit safety specification defines that an X capacitor (X-cap) needs to be parallel to a discharge resistor to discharge a voltage stored in the X capacitor to be lower than a safety voltage within one second when the electronic device is turned off. However, the discharge resistor still has constant power consumption when the electronic device operates normally. Taking the X capacitor (0.47 μF) and the discharge resistor (2 MΩ) for example, power consumption of the discharge resistor is 35 mW when an input alternating current voltage is 264V. Therefore, when the electronic device resides in a long-term standby mode (such as an inverter of a mobile phone or an adaptor of a notebook), the power consumption of the discharge resistor is a waste for a user.

### SUMMARY OF THE INVENTION

An embodiment provides a circuit for discharging an X capacitor. The circuit includes an AC detection unit, a reset unit, a counter, and a discharging unit. The AC detection unit is coupled to two terminals of the X capacitor through a pin. The AC detection unit has a plurality of reference levels for detecting a level of a direct current (DC) voltage according to the plurality of reference levels, and outputting a detection signal. The reset unit is coupled to the AC detection unit for generating a reset signal according to the detection signal. The counter is coupled to the reset unit for being reset according to the reset signal. The counter generates a turning-on signal when the counter does not receive the reset signal within a first predetermined time. The discharging unit is coupled to the counter for discharging the X capacitor according to the turning-on signal.

Another embodiment provides a circuit for discharging an X capacitor. The circuit includes an AC detection unit, a counter, and a discharging unit. The AC detection unit is coupled to two terminals of the X capacitor through a pin. The AC detection unit has a plurality of reference levels for detecting a DC voltage level according to the plurality of reference levels, and outputting a detection signal. The counter is coupled to the AC detection unit for being reset according to the detection signal. The counter generates a turning-on signal when the counter does not receive the reset signal within a first predetermined time. The discharging unit is coupled to the counter for discharging the X capacitor according to the turning-on signal.

The present invention provides a circuit for discharging an X capacitor. The circuit utilizes an AC detection unit to detect a DC voltage level of one terminal of the X capacitor according to a plurality of reference levels to generate a detection signal. Then, a counter can be reset according to the detection signal or a reset signal generated by a reset unit according to the detection signal. When the counter does not receive the reset signal or the detection signal within a first predetermined time, the counter generates a turning-on signal to a discharging unit. Therefore, the discharging unit can discharge a voltage stored in the X capacitor to be lower than a predetermined voltage within a second predetermined time according to the turning-on signal. Compared to the prior art, because the AC detection unit detects the DC voltage level of the terminal of the X capacitor according to the plurality of reference levels, the present invention can improve a condition in which the AC detection unit misjudges turning-off of an AC power.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a circuit for discharging an X capacitor according to an embodiment.

FIG. 2 is a timing diagram illustrating timings of the divided voltage, the detection signal, and the turning-on signal.

FIG. 3 is a diagram illustrating a circuit for discharging an X capacitor according to another embodiment.

FIG. 4 is a timing diagram illustrating timings of the divided voltage, the detection signal, the signal, the reset signal, and the turning-on signal.

### DETAILED DESCRIPTION

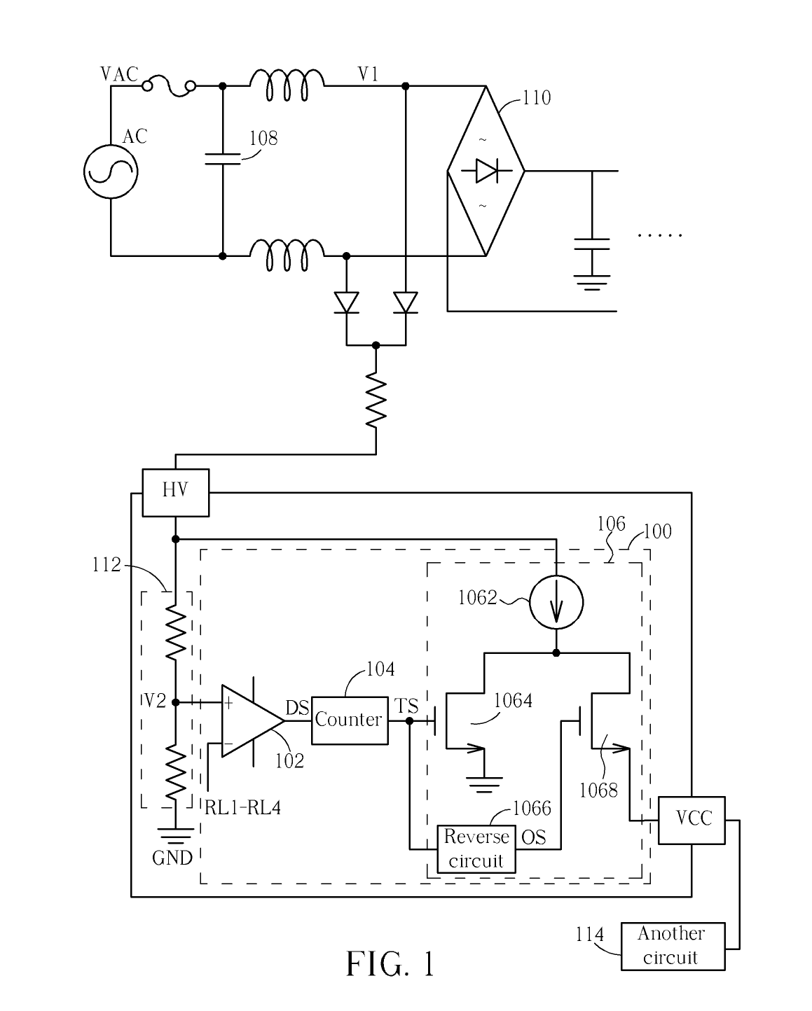

Please refer to FIG. 1. FIG. 1 is a diagram illustrating a circuit 100 for discharging an X capacitor according to an embodiment. The circuit 100 includes an AC detection unit 102, a counter 104, and a discharging unit 106. The AC detection unit 102 is coupled to two terminals of an X capacitor 108 through a pin HV, where the AC detection unit 102 has 4 reference levels RF1 to RF4. The AC detection unit 102 is used for detecting a DC voltage level V1 of one terminal of the X capacitor 108 according to the 4 reference levels RF1 to RF4 through a voltage divider 112, and outputting a detection signal DS. The voltage divider 112 is coupled between the pin HV and ground GND for providing a divided voltage V2 of the DC voltage V1 to the AC detection unit 102. In addition, in another embodiment of the present invention, the circuit 100 further includes the voltage divider 112. As shown in FIG. 1, an AC voltage VAC provided by an AC power AC is rectified by a full-wave rectifier 110 to generate the DC voltage V1. But, the present invention is not limited to the 4 reference levels RF1 to RF4. Any AC detection unit 102 having a plurality of reference levels falls within the scope of the present invention. The counter 104 is coupled to the AC detection unit 102 for being reset according to a detection signal DS. When the counter 104 does not receive the detection signal DS within a first predetermined time T1 (such as 40 ms), the counter 104 generates a turning-on signal TS. The discharging unit 106 coupled to the counter 104 includes a current source 1062 and a first transistor 1064 (such as a metal-oxide-semiconductor transistor). The first transistor 1062 is turned on according to the turning-on signal TS. When the first transistor 1062 is turned on, the current source 1062 and the first transistor 1064 form a discharging path to ground GND to discharge the X capacitor 108. Therefore, the discharging unit 106 can discharge a voltage stored in the X capacitor 108 to be lower than a predetermined voltage within a second predetermined time (such as one second) according to the turning-on signal TS. In addition, the discharging unit 106 further includes a reverse circuit 1066 and a second transistor 1068 (such as a metal-oxide-semiconductor transistor). The reverse circuit 1066 is used for reversing the turning-on signal TS to generate a turning-off signal OS. The second transistor 1068 is used for being turned off according to the turning-off signal OS, where the first transistor 1064 and the second transistor 1068 are not turned on and turned off simultaneously. Therefore, when the first transistor 1064 is turned off and the second transistor 1068 is turned on, current provided by the current source 1062 flows through the second transistor 1068 and a pin VCC to another circuit 114.

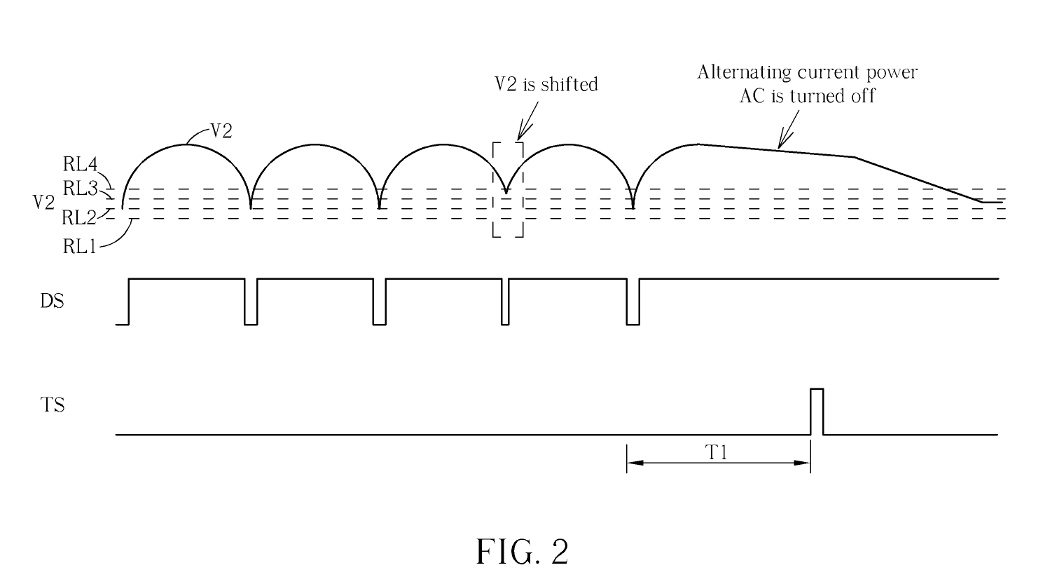

Please refer to FIG. 2. FIG. 2 is a timing diagram illustrating timings of the divided voltage V2, the detection signal DS, and the turning-on signal TS. As shown in FIG. 2, when the AC power AC provides the AC voltage VAC normally, the divided voltage V2 has rising slopes and falling slopes within each period of the divided voltage V2. In addition, because the AC detection unit 102 has the 4 reference levels RF1 to RF4, the AC detection unit 102 can still generate and output the detection signal DS according to at least one reference level of the 4 reference levels RF1 to RF4 when the AC power AC is shifted to cause the divided voltage V2 to also be shifted. For example, although the divided voltage V2 is shifted in a dotted line rectangle shown in FIG. 2, the AC detection unit 102 can still generate and output a detection signal DS according to the reference level RF4. Therefore, when the AC power AC provides the AC voltage VAC normally, the counter 104 does not generate the turning-on signal TS because the counter 104 can continue being reset according to the detection signal DS. In addition, the divided voltage V2 does not have rising slopes and falling slopes when the AC power AC is turned off at a crest of the AC voltage VAC or at a trough of the AC voltage VAC. Therefore, if the counter 104 does not receive the detection signal DS within the first predetermined time T1, the counter 104 generates the turning-on signal TS to the discharging unit 106. Then, the discharging unit 106 can discharge the voltage stored in the X capacitor 108 to be lower than the predetermined voltage within the second predetermined time according to the turning-on signal TS.

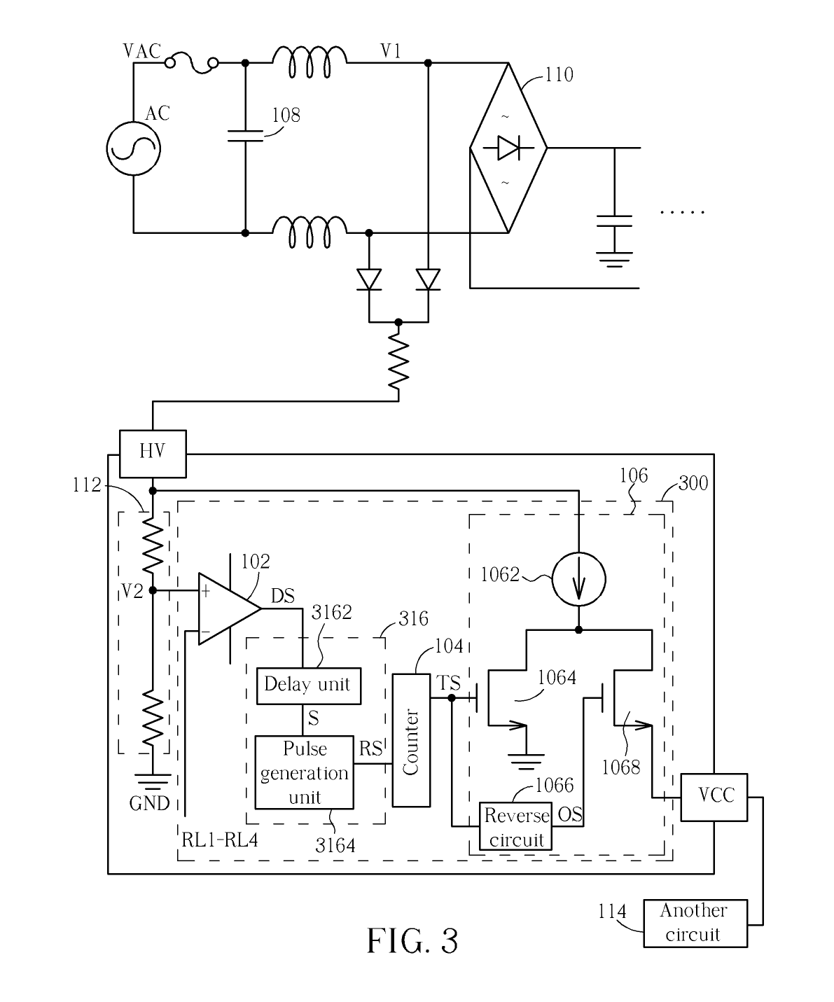

Please refer to FIG. 3. FIG. 3 is a diagram illustrating a circuit 300 for discharging an X capacitor according to another embodiment. A difference between the circuit 300 and the circuit 100 is that the circuit 300 further includes a reset unit 316. The reset unit 316 is coupled between the AC detection unit 102 and the counter 104. The reset unit 316 includes a delay unit 3162 and a pulse generation unit 3164. The delay unit 3162 is used for generating a signal S according to a detection signal DS, where the delay unit 3162 has a delay time (such as 160 μs) to prevent the delay unit 3162 from generating the signal S according to noise. The pulse generation unit 3164 is used for generating a reset signal RS according to the signal S. The counter 104 is coupled to the reset unit 316 for being reset according to the reset signal RS. When the counter 104 does not receive the reset signal RS within a first predetermined time T1, the counter 104 generates a turning-on signal TS to the discharging unit 106. Further, subsequent operational principles of the circuit 300 are the same as those of the circuit 100, so further description thereof is omitted for simplicity.

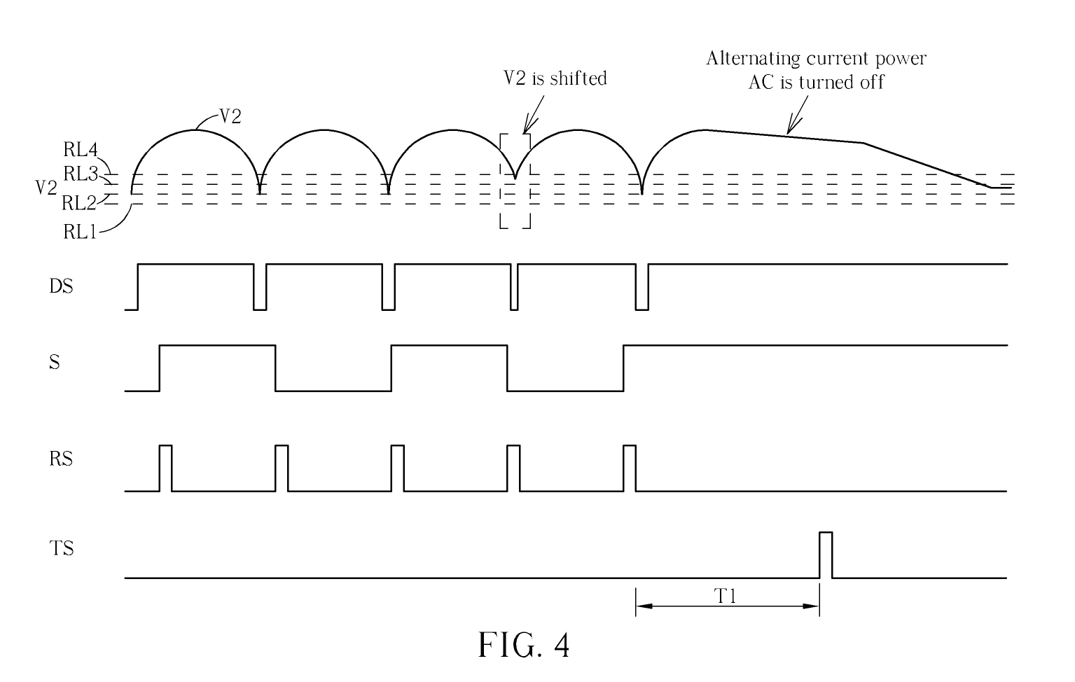

Please refer to FIG. 4. FIG. 4 is a timing diagram illustrating timings of the divided voltage V2, the detection signal DS, the signal S, the reset signal RS, and the turning-on signal TS. As shown in FIG. 4, when the AC power AC provides an AC voltage VAC normally, the divided voltage V2 has rising slopes and falling slopes within each period of the divided voltage V2. When the AC power AC provides the AC voltage VAC normally, the counter 104 does not generate the turning-on signal TS because the counter 104 can continue being reset according to the reset signal RS. In addition, the divided voltage V2 does not have rising slopes and falling slopes when the AC power AC is turned off. If the counter 104 does not receive the reset signal RS within a first predetermined time T1, the counter 104 generates the turning-on signal TS to the discharging unit 106. Then, the discharging unit 106 can discharge the voltage stored in the X capacitor 108 to be lower than a predetermined voltage within a second predetermined time according to the turning-on signal TS.

To sum up, the circuit for discharging the X capacitor utilizes the AC detection unit to detect a DC voltage level of one terminal of the X capacitor according to the plurality of reference levels to generate a detection signal. Then, the counter can be reset according to the detection signal or a reset signal generated by the reset unit according to the detection signal. When the counter does not receive the reset signal or the detection signal within the first predetermined time, the counter generates a turning-on signal to the discharging unit. Therefore, the discharging unit can discharge a voltage stored in the X capacitor to be lower than the predetermined voltage within the second predetermined time according to the turning-on signal. Compared to the prior art, because the AC detection unit detects the DC voltage level of the terminal of the X capacitor according to the plurality of reference levels, the present invention can improve a condition in which the AC detection unit misjudges turning-off of the AC power.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A circuit for discharging an X capacitor, the circuit comprising:
an AC detection unit coupled to two terminals of the X capacitor through a pin, wherein the AC detection unit has a plurality of reference levels for detecting a DC voltage level according to the plurality of reference levels, and outputting a detection signal;
a reset unit coupled to the AC detection unit for generating a reset signal according to the detection signal;
a counter coupled to the reset unit for being reset according to the reset signal, wherein the counter generates a turning-on signal when the counter does not receive the reset signal within a first predetermined time; and
a discharging unit coupled to the counter for discharging the X capacitor according to the turning-on signal.

2. The circuit of claim 1, wherein the discharging unit comprises:
a current source; and
a first transistor for being turned on according to the turning-on signal, wherein the current source and the first transistor form a discharging path to ground to discharge the X capacitor when the first transistor is turned on.

3. The circuit of claim 2, wherein the discharging unit further comprises:
a reverse circuit for reversing the turning-on signal to generate a turning-off signal; and
a second transistor for being turned off according to the turning-off signal, wherein the first transistor and the second transistor are not turned on and turned off simultaneously.

4. The circuit of claim 1, further comprising:
a voltage divider coupled between the pin and ground for providing
a divided voltage of the DC voltage to the AC detection unit.

5. The circuit of claim 1, wherein the discharging unit discharges a voltage of the X capacitor to be lower than a predetermined voltage within a second predetermined time according to the turning-on signal.

6. The circuit of claim 5, wherein the second predetermined time is one second.

7. A circuit for discharging an X capacitor, the circuit comprising:
an AC detection unit coupled to two terminals of the X capacitor through a pin, wherein the AC detection unit has a plurality of reference levels for detecting a DC voltage level according to the plurality of reference levels, and outputting a detection signal;
a counter coupled to the AC detection unit for being reset according to the detection signal, wherein the counter generates a turning-on signal when the counter does not receive the reset signal within a first predetermined time; and
a discharging unit coupled to the counter for discharging the X capacitor according to the turning-on signal.

8. The circuit of claim 7, wherein the discharging unit comprises:
a current source; and
a first transistor for being turned on according to the turning-on signal, wherein the current source and the first transistor form a discharging path to ground to discharge the X capacitor when the first transistor is turned on.

9. The circuit of claim 8, wherein the discharging unit further comprises:
a reverse circuit for reversing the turning-on signal to generate a turning-off signal; and
a second transistor for being turned off according to the turning-off signal, wherein the first transistor and the second transistor are not turned on and turned off simultaneously.

10. The circuit of claim 8, further comprising:
a voltage divider coupled between the pin and ground for providing a divided voltage of the DC voltage to the AC detection unit.

11. The circuit of claim 8, wherein the discharging unit discharges a voltage of the X capacitor to be lower than a predetermined voltage within a second predetermined time according to the turning-on signal.

12. The circuit of claim 11, wherein the second predetermined time is one second.

13. The circuit of claim 8, wherein the reset unit comprises:
a delay unit for generating a signal according to the detection signal, wherein the delay unit has a delay time for preventing the delay unit from generating the signal according to noise; and
a pulse generation unit for generating the reset signal according to the signal.
